(19) United States
(12) Patent Application Publication
(10) Pub. No.: US 2008/0267167 A1
(43) Pub. Date: Oct. 30, 2008

(54) SYSTEM AND METHOD FOR SET UP OF AN IP COMMUNICATION TO THE ORIGIN OF A CIRCUIT SWITCHED CALL

(76) Inventor: Johan APELQVIST, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/741,037

(22) Filed: Apr. 27, 2007

(51) Int. Cl. H04L 12/66

(52) U.S. Cl. 370/352

(57) ABSTRACT

A mobile device for operation within a service provider's wide area wireless network system comprises a wireless communication system, a circuit switched application, and an IP application. The circuit switched application receives circuit switched call signaling from the wireless service provider network. The circuit switched call signaling comprises an MSISDN identifying the origin of a circuit switched call. The IP application determines whether the origin of the circuit switched call is capable of internet protocol communications by querying a contact database (or receiving an alert from the service provider network) to determine whether the MSISDN identifying the origin of the circuit switched call is associated with a unique uniform resource identifier. If the origin of the circuit switched call is capable of internet protocol communications, initiating an internet protocol communication thereto.

### TECHNICAL FIELD OF THE INVENTION

The present invention relates to mobile electronic devices and, in particular, to mobile electronic devices which include both wireless circuit switched communication capabilities and IP communication capabilities.

### DESCRIPTION OF THE RELATED ART

Contemporary portable devices, including mobile telephones, portable data assistants (PDAs), and other mobile electronic devices have typically included embedded applications which support circuit switched telephony within a service provider's wide area network utilizing communication standards such as GSM. Further, such systems typically support operation of variety of applications beyond traditional wireless telephony applications. Such applications may utilize Internet Protocols for communication of data with remote devices over the service provider's networks. Standards such as GPRS and EDGE are utilized for the wireless exchange of data and newer standards supporting faster data rates are being developed.

In typical operation, an originating endpoint will initiate a circuit switched call by “dialing” the telephone number associating with the desired terminating endpoint. The wireless network will page the terminating endpoint, the terminating endpoint will request a radio resource channel for supporting the telephone call, and call set up will commence over such channel. The channel is dedicated to the transfer of digital audio for the duration of the call.

In a mobile device that includes an integrated internet protocol communication suite, internet protocol communication may be used for such things as determining a contact's availability, initiating a chat session with a compatible device, initiating a VoIP telephony session with a compatible device, exchanging real time video with a compatible device, and exchanging files with a remote device.

For each of these services, a device includes a unique SIP Uniform Resource Identifier. SIP compliant network infrastructure (such as SIP Proxy Servers and Redirect Servers) enable a device to initiate a session to another device by initiating an SIP Session Invite message identifying the target device by its SIP URI.

A problem exists in that if a circuit switched telephone call is set up between two endpoints, the terminating device does not know if the originating device is capable of internet protocol communications and, if the originating device is capable of internet protocol communications, there exists no convenient method to establish a simultaneous internet protocol communication between the two devices for supporting such services as the exchange of files, the exchange of real time video, or text chat.

What is needed is a mobile device and method of operating a mobile device which enables a terminating endpoint of a circuit switched telephone call to initiate an internet protocol communication to the originating endpoint of the circuit switched telephony call—if the originating endpoint is an internet protocol compatible device.

### SUMMARY

A first aspect of the present invention comprises a mobile device for operation within a service provider's wide area wireless network system. The mobile device comprises a wireless communication system for communication with the service provider network. Communication with the service provider network may include supporting internet protocol communications utilizing a shared channel and supporting circuit switched telephone calls over a dedicated channel assigned by the service provider network for supporting such telephone call.

A circuit switched application is coupled to the wireless communication system. The circuit switched application receives circuit switched call signaling from the service provider network and supports circuit switched telephone calls. The circuit switched call signaling may comprise an MSISDN identifying the origin of a circuit switched call.

An IP application is also coupled to the wireless communication system. The IP application determines whether the origin of the circuit switched call is capable of internet protocol communications by querying a contact database to determine whether the MSISDN identifying the origin of the circuit switched call is associated with a unique uniform resource identifier. Alternatively, the service provider network may provide the uniform resource identifier as part of an alert message delivered at the time of signaling the circuit switched call. The alert message may be provided utilizing the shared channel or utilizing a sub-channel of the dedicated channel assigned for supporting the circuit switched call.

If the origin of the circuit switched call is capable of internet protocol communications, the IP application initiates an internet protocol communication thereto. The uniform resource identifier may be a Session Initiation Protocol (SIP) Uniform Resource Identifier (URI).

In one embodiment, the mobile device may further include the contact database. The contact database comprises a plurality of MSISDN numbers and associates at least a portion of the plurality of MSISDN numbers with a corresponding SIP URI.

In such embodiment, the IP application initiates the internet protocol communication to the origin of the circuit switched call by: i) obtaining, from the contact database, the SIP URI which corresponds to the MSISDN identifying the origin of the circuit switched call; and ii) initiating the internet protocol communication to the origin of the circuit switched call by initiating a SIP Session Invite message to a SIP proxy server which includes the corresponding SIP URI as the SIP Session Invite message's identification of the terminating device of the internet protocol communication.

In another embodiment, the contact database may be a remote contact database accessible via the service provider network. In such embodiment, the IP application initiates the internet protocol communication to the origin of the circuit switched call by: i) querying the remote contact database to obtain the SIP URI which corresponds to the MSISDN identifying the origin of the circuit switched call; and ii) initiating the internet protocol communication to the origin of the circuit switched call by initiating a SIP Session Invite message to a SIP proxy server which includes the corresponding SIP URI as the SIP Session Invite message's identification of the terminating device of the internet protocol communication.

In yet another embodiment, the mobile device further comprises the contact database and a remote contact database is accessible via the service provider network. Again, the contact database comprises a plurality of MSISDN numbers and associates at least a portion of the plurality of MSISDN numbers with a corresponding SIP URI.

In such embodiment, the application obtains the SIP URI corresponding to the MSISDN identifying the origin of the circuit switched call by: i) querying the contact database and obtaining the SIP URI from the contact database if the MSISDN is associated with a corresponding SIP URI in the contact database; and ii) querying a remote database and obtaining the SIP URI from the remote database if the MSISDN is not associated with a corresponds SIP URI in the contact database. If the SIP URI is obtained from the remote database, the IP applicably may add the MSISDN and the SIP URI to the database.

A second aspect of the present invention also comprises a mobile device for operation within a service provider's wide area wireless network. The mobile device comprises a wireless communication system for communication with the service provider network. Again, communication with the service provider network may include supporting internet protocol communications utilizing a shared channel and supporting circuit switched telephone calls over a dedicated channel assigned by the service provider network for supporting such telephone call.

The circuit switched application is coupled to the wireless communication system for receiving circuit switched call signaling from the service provider network and supporting a circuit switched call. The circuit switched call signaling includes an MSISDN identifying the origin of a circuit switched call.

An IP application is coupled to the wireless communication system. The IP application obtains, from a contact database (or via an alert from the service provider network), a Session Initiation Protocol Uniform Resource Identifier (SIP URI) corresponding to the MSISDN identifying the origin of the circuit switched call. The IP application then initiates an internet protocol communication to the origin of the circuit switched call by initiating a SIP Session Invite message to a SIP proxy server which includes the corresponding SIP URI as the SIP Session Invite message's identification of the terminating device of the internet protocol communication.

Again, in one embodiment, the mobile device may further include the contact database. The contact database comprises a plurality of MSISDN numbers and associates at least a portion of the plurality of MSISDN numbers with a corresponding uniform resource identifier.

In such embodiment, the IP application initiates the internet protocol communication to the origin of the circuit switched call by: i) obtaining, from the contact database, the SIP URI which corresponds to the MSISDN identifying the origin of the circuit switched call; and ii) initiating the internet protocol communication to the origin of the circuit switched call by initiating a SIP Session Invite message to a SIP proxy server which includes the corresponding SIP URI as the SIP Session Invite message's identification of the terminating device of the internet protocol communication.

Again, in another embodiment, the contact database may be a remote contact database accessible via the service provider network. In such embodiment, the IP application initiates the internet protocol communication to the origin of the circuit switched call by: i) querying the remote contact database to obtain the SIP URI which corresponds to the MSISDN identifying the origin of the circuit switched call; and ii) initiating the internet protocol communication to the origin of the circuit switched call by initiating a SIP Session Invite message to a SIP proxy server which includes the corresponding SIP URI as the SIP Session Invite message's identification of the terminating device of the internet protocol communication.

Again, in yet another embodiment, the mobile device further comprises the contact database and a remote contact database is accessible via the service provider network. Again, the contact database comprises a plurality of MSISDN numbers and associates at least a portion of the plurality of MSISDN numbers with a corresponding SIP URI.

In such embodiment, the application obtains the SIP URI corresponding to the MSISDN identifying the origin of the circuit switched call by: i) querying the contact database and obtaining the SIP URI from the contact database if the MSISDN is associated with a corresponding SIP URI in the contact database; and ii) querying a remote database and obtaining the SIP URI from the remote database if the MSISDN is not associated with a corresponding SIP URI in the contact database. If the SIP URI is obtained from the remote database, the IP applicably may add the MSISDN and the SIP URI to the database.

A third aspect of the present invention is to provide a method of operating a mobile device, within a service provider's wide area wireless network, for establishing an internet protocol communication to a device originating a circuit switched call to the mobile device.

The method comprises receiving, from the service provider network, circuit switched call signaling addressed to the mobile device. The circuit switched call signaling comprises an MSISDN identifying the origin of a circuit switched call.

The method further comprises determining whether the device originating the circuit switched call is capable of internet protocol communication by querying a contact database (or receiving an alert from the service provider network) to determine whether the MSISDN identifying the origin of the circuit switched call is associated with a unique uniform resource identifier. If the device originating the circuit switched call is capable of internet protocol communication, the method comprises initiating an internet protocol communication thereto.

The uniform resource identifier may comprise a Session Initiation Protocol Uniform Resource Identifier (SIP URI). Initiating the internet protocol communication to the origin of the circuit switched call may be by initiating a SIP Session Invite message to a SIP proxy server which includes the corresponding SIP URI as the SIP Session Invite message's identification of the terminating device of the internet protocol communication.

In one embodiment, querying a contact database to determine whether an MSISDN identifying the origin of the circuit switched call is associated with a unique uniform resource identifier may comprise querying a local contact database maintained by the mobile device. The local contact database may comprise a plurality of MSISDN numbers and associate at least a portion of the plurality of MSISDN numbers with a corresponding uniform resource identifier.

In another embodiment, querying the contact database to determine whether an MSISDN identifying the origin of the circuit switched call is associated with a unique uniform resource identifier may comprise querying a remote contact database accessible via the service provider network.

In yet another embodiment, querying the contact database to determine whether an MSISDN identifying the origin of the circuit switched call is associated with a unique uniform resource identifier may comprise: i) querying a local contact database maintained by the mobile device and obtaining the SIP URI from the local contact database if the MSISDN is associated with a corresponding SIP URI in the local contact database; and ii) querying a remote database and obtaining the SIP URI from the remote database if the MSISDN is not associated with a corresponding SIP URI in the contact database. If the SIP URI is obtained from the remote database, the method may include adding the MSISDN and the SIP URI to the local contact database.

In all aspects and all embodiments of the present invention, the internet protocol communication may include: i) a real time protocol data stream representing a transfer of streaming video between the mobile device and the origin of the circuit switched call; ii) a file transfer between the mobile device and the origin of the circuit switched call; and/or iii) a VoIP session established between the mobile device and the origin of the circuit switched call.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is diagram representing exemplary architecture for a mobile device and method of operating a mobile device for establishing an internet communication with an originating device of a circuit switched telephone call;

FIG. 2 is ladder diagram representing a mobile device and method of operating a mobile device for establishing an internet communication with an originating device of a circuit switched telephone call in accordance with one embodiment of the present invention; and

FIG. 3 is a table diagram representing a SIP Session Invite message in accordance with one embodiment of the present invention.

### DETAILED DESCRIPTION OF EMBODIMENTS

The term “electronic equipment” as referred to herein includes portable radio communication equipment. The term “portable radio communication equipment”, also referred to herein as a “mobile radio terminal” or “mobile device”, includes all equipment such as mobile phones, pagers, communicators, e.g., electronic organizers, personal digital assistants (PDAs), smart phones or the like.

Many of the elements discussed in this specification, whether referred to as a “system” a “module” a “circuit” or similar, may be implemented in hardware circuit(s), a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

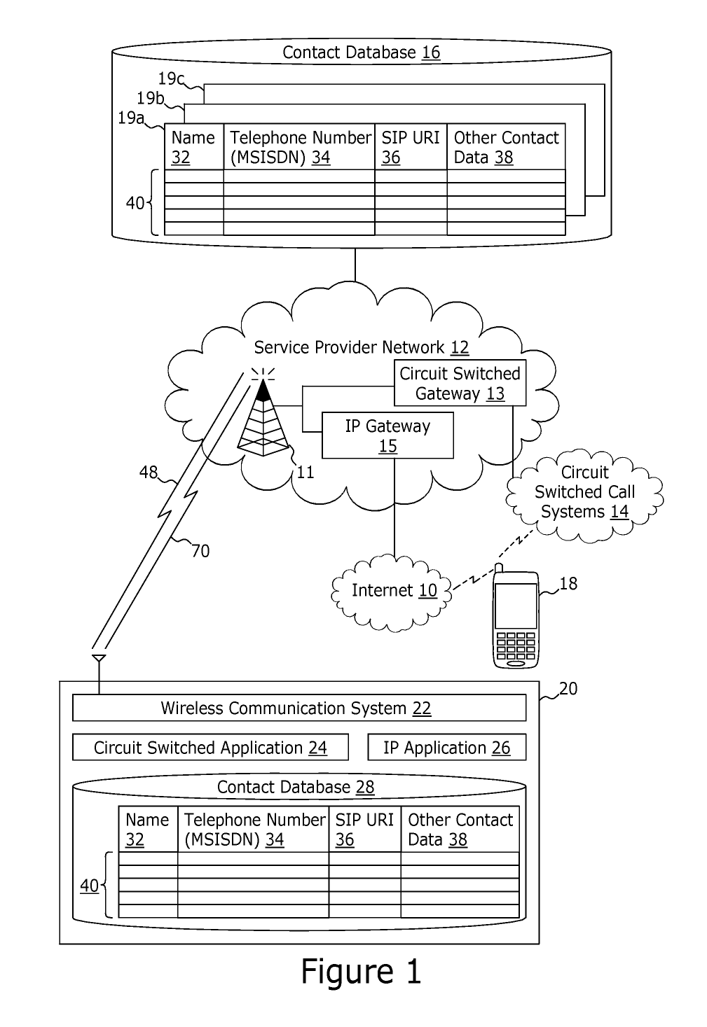

With reference to FIG. 1, a mobile device 20 may be some from of portable radio communication equipment such as a mobile telephone, PDA, or other mobile device capable of operating within a network service provider's wide area wireless network system (service provider network 12).

In an exemplary embodiment, the service provider network 12 may be a GSM network comprising one or more access points 11 each of which may be a mobile network base station such as a GSM Base Station System comprising a Base Station Controller and one or more Base Transceiver Stations. Each access point 11 may be communicatively coupled to a circuit switched gateway 13 for signaling, set up, and maintenance of circuit switched telephone calls between mobile devices (such as mobile device 20) and circuit switched call networks 14 such as the PSTN. The access point 11 may also be coupled to an IP gateway 15 for the exchange of internet protocol packets between mobile devices (such as mobile device 20) and other devices coupled to the internet 10.

In one embodiment of the present invention, the service provider network 12 may also comprise a contact database 16 storing contact record information for one or more supported mobile devices 20. In more detail, the contact database 16 may store contact data for each of the plurality of mobile devices. Contact data for each mobile device may be stored in a contact table 19a-19c. Each contact table 19a-19c may comprise a plurality of records 40. Each record 40 associates a contact with the user of the mobile device 20. The contact may be identified by name in a Name field 32. The record 40 associates the contact with his or her circuit switched telephone number (e.g. mobile station international subscriber directory number or MSISDN) stored in a Telephone Number field 34, Session Initiation Protocol Universal Resource Identifier (SIP URI) or other unique identifier of the contact useful to establishing internet based communications with the contact in a SIP URI field 36, and other contact information stored in one or more other contact data fields 38.

The mobile device 20 may comprise a wireless communication system 22, a circuit switched telephone application 24, an internet protocol communication application 26, and a contact database 28.

The wireless communication system 22 may communicate over designated wireless channels 48 and 70 with an access point 11 of the service provider network 12. In the exemplary service provider network 12, each channel 48 and 70 is defined utilizing a time division multiple access (TDMA) and frequency division multiple access (FDMA) system. The wireless communication system 22 may support internet protocol based communications over a shared channel 70 and support circuit switched telephone calls over a dedicated channel 48 (such as a radio resource channel) which is assigned by the service provider network 12 for purposes of supporting a particular circuit switched telephone call.

The shared channel 70 for internet protocol based communications may comprise a particular channel dedicated for internet protocol communications utilizing a protocol such as GRPS, EDGE, or similar multiple access channel such as those being proposed for what is commonly known as 3G communication networks.

A circuit switched application 24 is coupled to the wireless communication system 22. The circuit switched application 24 receives circuit switched call signaling from the network system 12 and supports circuit switched telephone calls utilizing dedicated channels 48. For purposes of illustrating the present invention, the circuit switched call signaling may comprise at least an MSISDN (e.g. caller ID number) identifying the origin of a circuit switched call.

The internet protocol communication application 26 is also coupled to the wireless communication system. The internet protocol communication application 26 may be a combination of an IP stack and a higher level application such as integrated communication suite for supporting internet communication services such as Voice over IP (VoIP), chat, file transfer, real time video exchange, and presence monitoring (e.g. buddy list).

The contact database 28 may comprises a plurality of records 40. Each record 40 associates a contact, whom may be identified by name in a Name field 32, with the contacts circuit switched telephone number (e.g. MSISDN) stored in a Telephone Number field 34, SIP URI or other unique identifier of the contact useful to establishing internet based communications with the contact in a SIP URI field 36, and other contact information stored in one or more other contact data fields 38.

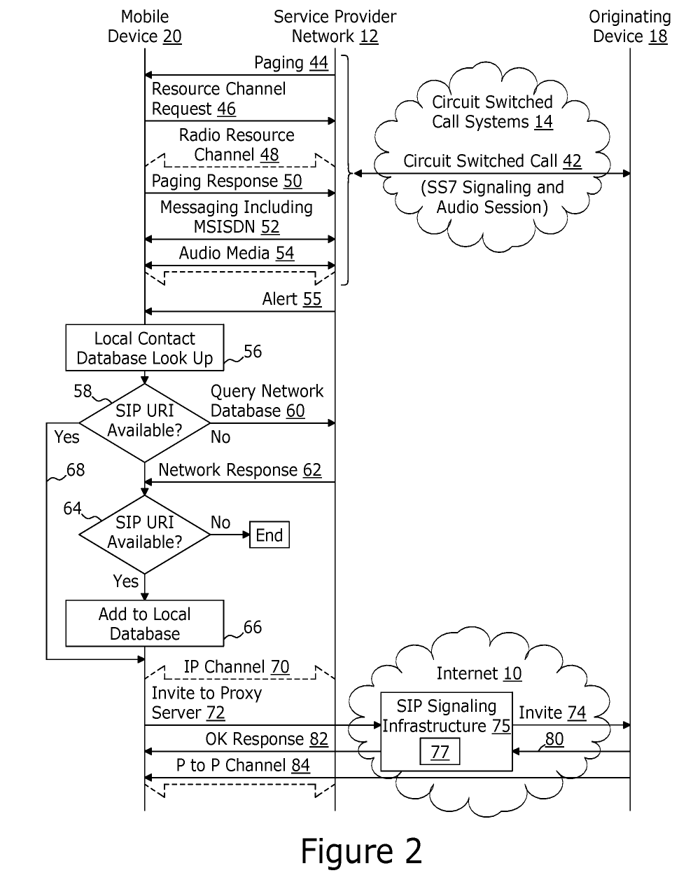

The ladder diagram of FIG. 2 represents exemplary operation of the mobile device 20 for initiating an internet protocol based communication to the origin of a circuit switched call (e.g. device 18 in this example).

Referring to FIG. 2 in conjunction with FIG. 1, a circuit switched call is initially signaled from the originating device 18 to the service provider network 12 supporting the mobile device 20 through circuit switched call systems 14—typically using SS7 signaling protocols. In more detail, the MSISDN of the mobile device 20, when dialed by the originating device 18, initiates the SS7 signaling to the service provider network 12 supporting the mobile device 20. The signaling and subsequent audio session through the circuit switched call systems 14 is represented by step 42.

Upon the service provider network 12 receiving signaling from the circuit switched call systems 14, the service provider network 12 may initiate broadcast of a paging message 44 on a paging channel from those access points 11 controlling cells within which the mobile device 20 is likely to exists.

The mobile device 20, upon detecting a paging message 44 indicating an incoming circuit switched call terminating at the mobile device 20, generates a radio resource channel request 46 to the access point 11.

In response to the radio resource channel request 46, the service provider network 12 assigns a radio a resource channel 48 for supporting “in-band” signaling messages and the audio media of the circuit switched call.

Utilizing the radio resource channel 48, the mobile device 20 generates a response to the paging message 44 (step 50) and the mobile device 20 and the service provider network 12 exchange various call signaling messaging 52 for establishing ciphering, providing the MSISDN (e.g. caller ID number) of the originating device 18 to the mobile device 20, notification of alerting status, and connection. After call set up, the audio media of the circuit switched call is exchanged between the mobile device 20 and the originating device 18 as represented by 54 and 42. The audio media exchange 54 between the mobile device 20 and the service provider system 12 utilizes the radio resource channel 48 assigned for purposes of the circuit switched call.

In accordance with the present invention, if the originating device 20 is capable of internet protocol based communications, it is desirable for the mobile device 20 to establish point to point internet protocol communication with the originating device 18 for purposes inclusive of file sharing, transfer of real time video, VoIP communications, chat sessions, and exchanging presence/availability data (e.g. typical buddy list information).

In the event that the service provider network 12 is able to identify the originating device 18 as being capable of internet protocol based communications—such as by determining whether a SIP URI of the originating device 18 is available in any of the tables 19a-19c of the contact database 16, the service provider network 12 may, as one embodiment of the present invention, provide an alert 55. The alert 55 may be sent to the IP application 26 of the mobile device 20 utilizing the shared channel 70. The alert 55 may be in the form of presence/availability data exchanged with the mobile device 20 over an IP connection established for such exchange. Alternatively, the alert 55 may be sent to the mobile device 20 utilizing a sub-channel of the dedicated radio resource channel 48 assigned for purposes of the circuit switched call.

It should be appreciated that the service provider network 12 may not configured to provide an alert 55 or that a SIP URI of the originating device 18 may be unavailable to the service provider network 12 at the time of the circuit switched call. As such, step 56 represents the mobile device 20, and in particular the IP application 26 of the mobile device 20, querying the contact database 28 to obtain a SIP URI of the originating device 18. In more detail, the IP application 26 determines whether a record 40 of the contact database 28 includes the MSISDN (field 34) of the originating device 18 and, associates therewith, a SIP URI (field 36).

If, at step 58, a SIP URI of the originating device 18 is available in the contact database 28, it can be concluded that the originating device 18 is capable of point to point internet based communications may be established.

If, at step 58, a SIP URI of the originating device 18 is not available in the contact database 28, the mobile device 20 may query the contact database 16 of the network systems 16 at step 60. The service provider network 12 may provide a response 62. If the SIP URI of the originating device 18 is available in any of the tables 19a-19c, the response 62 may includes such SIP URI. If unavailable, the response will so indicate.

If at step 64, a SIP URI of the originating device 18 is available in the contact database 16, it can be concluded that the originating device 18 is capable of point to point internet based communications may be established and, at step 66, the contact information obtained from the contact database 16 (including the SIP URI) may be written to the database 28 for future reference.

If the originating device 18 is determined to be capable of point to point internet based communications at either step 58 or step 66, the mobile device 20 may initiate such communication by sending an invite message 72 to SIP signaling infrastructure 75.

In more detail, the mobile device 20 may utilize the shared channel 70 utilized for internet communications (e.g. Internet Channel 20) supported by the service provider network 12 for sending a SIP Session Invite message to a SIP Proxy Server 77 with which the mobile device 20 is registered.

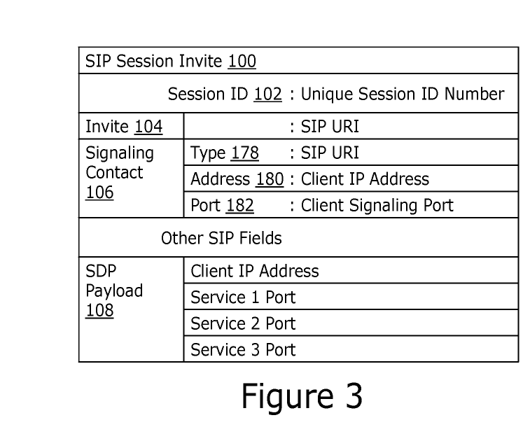

Turning briefly to FIG. 3, an exemplary SIP Session Invite message 100 may include: i) a unique session identifier 102; ii) an Invite header 104 identifying the SIP URI of the originating device 18 as identification of the terminating device of the SIP signaling; iii) a signaling contact header 106 identifying the mobile device 20 by its SIP URI as well as identifying the IP address and SIP signaling port of the mobile device 20; iv) various other SIP fields; and v) Session Description Protocol (SDP) Payload 108 identifying the IP address of the mobile device and port numbers utilized for the point to point exchange of internet communications.

Returning to FIG. 2 in conjunction with FIG. 1, step 74 represents the SIP Signaling infrastructure 75 (for example a combination of Proxy Servers and Redirect Servers) locating and generating a SIP Session Invite message to the originating device 18. Steps 80 and 82 represent exchange of various other SIP signaling messages, including an OK Response which culminate in establishing point to point to point internet communications 84. The point to point internet communications 84 are transferred between the mobile device 20 and the service provider network 12 utilizing the IP channel 70.

It should be appreciated that the systems and methods of the present invention enable a terminating device of a circuit switched call to determine wither the originating device is internet communication capable and initiate a point to point internet communication to the originating device.

Although the invention has been shown and described with respect to certain preferred embodiments, it is obvious that equivalents and modifications will occur to others skilled in the art upon the reading and understanding of the specification.

For example, the ladder diagram of FIG. 2 represents the mobile device first attempting to locate a SIP URI for the originating device 18 in a local database and, if unavailable, attempting to locate a SIP URI by querying a network database. Those skilled in the art will appreciate that: i) the order may be reversed; ii) if a local database is not present, only a remote query may be used; and/or iii) if a remote database is not available, only a local database may be used.

As another example, the ladder diagram of FIG. 2 represents the mobile device 20 completing set up of the circuit switched telephone call prior to initiating steps for setting up the internet communication to the originating device 18. Those skilled in the art will appreciate that the steps related to determining whether the originating device 18 is capable of internet communications and initiating set up of an internet communication may commence at any time after the mobile device 20 receives the MSISDN of the originating device 18. The present invention includes all such equivalents and modifications, and is limited only by the scope of the following claims.

1. A mobile device for operation within a service provider's wide area wireless network system, the mobile device comprising:
a wireless communication system for communication with the wireless network system;
a circuit switched application coupled to the wireless communication system for receiving circuit switched call signaling from the wireless network system, the circuit switched call signaling comprising an MSISDN identifying the origin of a circuit switched call; and
an IP application coupled to the wireless communication system for:
determining whether the origin of the circuit switched call is capable of internet protocol communications; and
if the origin of the circuit switched call is capable of internet protocol communications, initiating an internet protocol communication thereto.

2. The mobile device of claim 1, wherein determining whether the origin of the circuit switched call is capable of internet protocol communications is by querying a contact database to determine whether the MSISDN identifying the origin of the circuit switched call is associated with a unique uniform resource identifier.

3. The mobile device of claim 2, further comprising the contact database, the contact database comprising a plurality of MSISDN numbers and associating at least a portion of the plurality of MSISDN numbers with a corresponding uniform resource identifier.

4. The mobile device of claim 3, wherein:
the uniform resource identifier is a SIP URI; and
the IP application initiates the internet protocol communication to the origin of the circuit switched call by:
obtaining, from the contact database, the SIP URI which corresponds to the MSISDN identifying the origin of the circuit switched call; and
initiating the internet protocol communication to the origin of the circuit switched call by initiating a SIP Session Invite message to a SIP proxy server which includes the corresponding SIP URI as the SIP Session Invite message's identification of the terminating device of the internet protocol communication.

5. The mobile device of claim 2, wherein:
the uniform resource identifier is a SIP URI;
the contact database is a remote contact database accessible via the wireless network system; and
the IP application initiates the internet protocol communication to the origin of the circuit switched call by:
querying the remote contact database to obtain the SIP URI which corresponds to the MSISDN identifying the origin of the circuit switched call; and
initiating the internet protocol communication to the origin of the circuit switched call by initiating a SIP Session Invite message to a SIP proxy server which includes the corresponding SIP URI as the SIP Session Invite message's identification of the terminating device of the internet protocol communication.

6. The mobile device of claim 2, wherein:
the uniform resource identifier is a SIP URI;
the mobile device further comprises the contact database, the contact database comprising a plurality of MSISDN numbers and associating at least a portion of the plurality of MSISDN numbers with a corresponding SIP URI; and
wherein the IP application obtains the SIP URI corresponding to the MSISDN identifying the origin of the circuit switched call by:
querying the contact database and obtaining the SIP URI from the contact database if the MSISDN is associated with a corresponding SIP URI in the contact database; and
querying a remote database and obtaining the SIP URI from the remote database if the MSISDN is not associated with a corresponds SIP URI in the contact database.

7. The mobile device of claim 6, wherein the IP application further, if the SIP URI is obtained from the remote database, adds the MSISDN and the SIP URI to the database.

8. The mobile device of claim 6, wherein the internet protocol communication includes a real time protocol data stream representing a transfer of streaming video between the mobile device and the origin of the circuit switched call.

9. The mobile device of claim 6, wherein the internet protocol communication includes a file transfer between the mobile device and the origin of the circuit switched call.

10. The mobile device of claim 1, wherein determining whether the origin of the circuit switched call is capable of internet protocol communications by receiving an alert, the alert being an internet protocol communication via the wireless network system and identifying a unique uniform resource identifier associated with the origin of the circuit switched call.

11. The mobile device of claim 12, wherein:
uniform resource identifier is a SIP URI; and
the IP application further associates the SIP URI with the MSISDN identifying the origin of the circuit stitched call in a local contact database.

12. The mobile device of claim 11, wherein initiating the internet protocol communication to the origin of the circuit switched call is by initiating a SIP Session Invite message to a SIP proxy server which includes the corresponding SIP URI as the SIP Session Invite message's identification of the terminating device of the internet protocol communication.

13. A mobile device for operation within a service provider's wide area wireless network system, the mobile device comprising:
a wireless communication system for communication with the wireless network system;
a circuit switched application coupled to the wireless communication system for receiving circuit switched call signaling from the wireless network system, the circuit switched call signaling including an MSISDN identifying the origin of a circuit switched call; and
an IP application coupled to the wireless communication system for:
obtaining, from a contact database, a SIP URI corresponding to the MSISDN identifying the origin of the circuit switched call; and
initiating the internet protocol communication to the origin of the circuit switched call by initiating a SIP Session Invite message to a SIP proxy server which includes the corresponding SIP URI as the SIP Session Invite message's identification of the terminating device of the internet protocol communication.

14. The mobile device of claim 13,
further comprising a contact database, the contact database comprising a plurality of MSISDN numbers and associating at least a portion of the plurality of MSISDN numbers with a corresponding SIP URI; and
wherein obtaining a SIP URI corresponding to the MSISDN identifying the origin of the circuit switched call comprises querying the contact database.

15. The mobile device of claim 13, wherein obtaining a SIP URI corresponding to the MSISDN identifying the origin of the circuit switched call comprises querying a remote contact database accessible via the wireless network systems.

16. The mobile device of claim 13:
further comprising the contact database, the contact database comprising a plurality of MSISDN numbers and associating at least a portion of the plurality of MSISDN numbers with a corresponding SIP URI; and
wherein the IP application obtains the SIP URI corresponding to the MSISDN identifying the origin of the circuit switched call by:
querying the contact database and obtaining the SIP URI from the contact database if the MSISDN is associated with a corresponding SIP URI in the contact database; and
querying a remote database and obtaining the SIP URI from the remote database if the MSISDN is not associated with a corresponds SIP URI in the contact database.

17. The mobile device of claim 16, wherein the IP application further, if the SIP URI is obtained from the remote database, adds the MSISDN and the SIP URI to the database.

18. The mobile device of claim 16, wherein the internet protocol communication includes a real time protocol data stream representing a transfer of streaming video between the mobile device and the origin of the circuit switched call.

19. The mobile device of claim 16, wherein the internet protocol communication includes a file transfer between the mobile device and the origin of the circuit switched call.

20. The mobile device of claim 13, wherein obtaining a SIP URI corresponding to the MSISDN identifying the origin of the circuit switched call comprises receiving an alert, the alert being an internet protocol communication via the wireless network system and identifying the SIP URI associated with the origin of the circuit switched call.

21. The mobile device of claim 20, wherein the IP application further associates the SIP URI with the MSISDN identifying the origin of the circuit switched call in a local contact database.

22.-39. (canceled)
